(19) United States
(12) Patent Application Publication
(10) Pub. No.: US 2025/0222971 A1
(43) Pub. Date: Jul. 10, 2025

(54) HEAD PROTECTION DEVICE AND INFANT CARRIER INCLUDING THE SAME

(71) Applicant: WONDERLAND SWITZERLAND AG, Steinhausen (CH)

(72) Inventors: Zhengwen GUO, Steinhausen (CH); Wuqing LIU, Steinhausen (CH)

(21) Appl. No.: 18/703,159

(22) PCT Filed: Oct. 20, 2022
(86) PCT No.: PCT/EP2022/079307

§ 371 Date: Apr. 19, 2024

(30) Foreign Application Priority Data
Oct. 20, 2021 (CN) 202111237459.X

(51) Int. Cl. B62B 9/10; A47D 15/00

(52) U.S. Cl. CPC B62B 9/106; A47D 15/005

(57) ABSTRACT

The invention discloses a head protection device and an infant carrier including the head protection device, which is suitable for being sleeved outside a shoulder strap of an infant carrier and an adjustment buckle wound around the shoulder strap, the shoulder strap is connected between a backrest and a seat body of the infant carrier, the head protection device comprises a protective sheet, a connecting member and a positioning member both disposed on the protective sheet, left and right ends of the protective sheet are detachably connected by the connecting member, so as to be capable of being sleeved outside the shoulder strap and the adjustment buckle, the positioning member is used to be clamped with the adjustment buckle and/or the shoulder strap wound around the adjustment buckle, such that the adjustment buckle and the shoulder strap wound around the adjustment buckle are always wrapped in the head protection device.

### CROSS-REFERENCE TO RELATED APPLICATIONS

This application is a National Stage application of PCT/EP2022/079307, entitled “HEAD PROTECTION DEVICE AND INFANT CARRIER INCLUDING THE SAME” and filed on Oct. 20, 2022, which claims the benefit of Chinese Application No. 202111237459.X, filed on Oct. 20, 2021, both of which are incorporated herein by reference in their entirety.

### TECHNICAL FIELD

The present invention relates to an infant carrier, and in particular to a head protection device sleeved on shoulder straps of an infant carrier and an infant carrier including the same.

### BACKGROUND

For parents having children at home, when they go out with their children, infant carriers such as baby strollers, baby baskets and safety seats are usually used instead of hand-holding, in order to reduce the burden on adults. Moreover, the infant carriers also have advantages of comfortable and safe in travelling. Therefore, the infant carriers are more and more favored by people. Based on safety considerations, the existing infant carriers are often equipped with shoulder straps and waist straps for securing babies and infants. A length of a shoulder strap is generally set to be adjustable, and the length of a shoulder strap is adjusted mostly by a buckle that is arranged on the shoulder strap. Among them, in order to improve comfort and safety in use, a protective sheet for wrapping the buckle is also sleeved on the shoulder strap, so as to protect the head and neck of the baby or infant.

However, the existing protective sheets are mostly only sleeved on the shoulder straps, and in the process of riding or in the process of adjusting the length of the shoulder straps, the protective sheet may be relatively moved and dislocated, so that the buckle is exposed outside the protective sheet, or alternatively, the shoulder straps are directly in contact with the head and neck of the head and neck of the baby or infant, thereby reducing the comfort in use, and even causing the head and neck of the baby or infant to be injured due to a collision or friction with the buckle or the shoulder straps, and cannot play a good role in protection.

Accordingly, there is an urgent requirement for a head protection device that is simple in structure, convenient in use, safe and reliable, and has no relative sliding with the shoulder straps even when a height adjustment of the shoulder straps is performed, as well as an infant carrier including the head protection device to overcome the above problem.

### SUMMARY

An purpose of the invention is to provide a head protection device which has no relative sliding with shoulder straps, is simple in structure, convenient to use and is safe and reliable, so as to ensure the safety and comfort of the infant carrier.

Another purpose of the invention is to provide an infant carrier which has no relative sliding with shoulder straps, is simple in structure, convenient to use and is safe and reliable, so as to ensure the safety and comfort of the infant carrier.

In order to achieve the above purposes, the invention provides a head protection device suitable for being sleeved outside a shoulder strap of an infant carrier and an adjustment buckle wound around the shoulder strap, the shoulder strap is connected between a backrest and a seat body of the infant carrier, the head protection device comprises a protective sheet, a connecting member and a positioning member both disposed on the protective sheet, left and right ends of the protective sheet are detachably connected by the connecting member, so as to be capable of being sleeved outside the shoulder strap and the adjustment buckle, the positioning member is used to be clamped with the adjustment buckle and/or the shoulder strap wound around the adjustment buckle, such that the adjustment buckle and the shoulder strap wound around the adjustment buckle are always wrapped in the head protection device.

Preferably, the protective sheet is arranged in a transverse width direction of the shoulder strap, so as to be wrapped only outside the adjustment buckle and the shoulder strap wound at the adjustment buckle.

Preferably, the protective sheet is arranged in a longitudinal direction of the shoulder strap, so as to be wrapped outside the adjustment buckle and a wrapping place of the shoulder strap which is wrapped with the adjustment buckle, and outside of an extending place of the shoulder strap which is connected to the wrapping place.

Preferably, the protective sheet is sheet-shaped, relatively soft and has certain elasticity.

Preferably, the protective sheet includes a wrapping layer and a fitting layer sewn connected together as a whole, the wrapping layer is used to contact the shoulder strap and the adjustment buckle, and the fitting layer is used to contact the infant.

Preferably, the protective sheet further includes a buffer layer, the buffer layer is disposed between the wrapping layer and the fitting layer, and the wrapping layer, the buffer layer and the fitting layer are sewn connected together as a whole.

Preferably, the protective sheet further includes a buffer layer, edges of both the wrapping layer and the fitting layer are sewn connected together as a whole, the wrapping layer is provided with a filling port, and the buffer layer is detachably filled between the wrapping layer and the fitting layer by the filling port.

Preferably, the connecting member is provided in a plurality, the plurality of connecting members are disposed on edges of a relative left end and a relative right end of the protective sheet, and the plurality of connecting members are arranged separately along a longitudinal direction of the head protection device.

Preferably, the shoulder strap is arranged adjustable in length.

Preferably, the positioning member is clamped with the shoulder strap in the transverse width direction of the shoulder strap and/or clamped with the adjustment buckle in a thickness direction of the shoulder strap.

Preferably, a clamping surface of the positioning member being clamped with the shoulder strap is a slope.

Preferably, the positioning member includes a clamping sheet and/or a hanger sheet disposed on the protective sheet, the clamping sheet is used to be clamped with the shoulder strap wound at the adjustment buckle, and the hanger sheet is used to be inserted into the adjustment buckle and clamped with the adjustment buckle.

Preferably, the shoulder strap includes an upper shoulder strap and a lower shoulder strap both wound around the adjustment buckle, an upper connecting end of the upper shoulder strap is connected to a relative upper end of the backrest, a lower connecting end of the upper shoulder strap is connected to a relative middle upper end of the backrest after being wound around the adjustment buckle, a connecting end of the lower shoulder strap is connected to the seat body, after a free end of the lower shoulder strap is wound around the adjustment buckle, a adjusting portion is formed between the free end and the adjustment buckle, and a connecting portion is formed between the connecting end and the adjustment buckle, the protective sheet is wrapped outside the adjustment buckle and the upper shoulder strap wound around the adjustment buckle, as well as the adjusting portion and the connecting portion of the lower shoulder strap, the clamping sheet is used to be clamped with the upper shoulder strap wound at the adjustment buckle from a relative front face or back face of the adjustment buckle, the hanger sheet is used to be inserted into the adjustment buckle from the relative back face of the adjustment buckle and clamped with the adjustment buckle on the relative front face of the adjustment buckle.

Preferably, the shoulder strap includes an upper shoulder strap and a lower shoulder strap both wound around the adjustment buckle, an upper connecting end of the upper shoulder strap is connected to a relative upper end of the backrest, a lower connecting end of the upper shoulder strap is folded upward to be connected to the upper shoulder strap after being wound around the adjustment buckle, a connecting end of the lower shoulder strap is connected to the seat body, after a free end of the lower shoulder strap is wound around the adjustment buckle, an adjusting portion is formed between the free end and the adjustment buckle, and a connecting portion is formed between the connecting end and the adjustment buckle, the protective sheet is wrapped outside the adjustment buckle and the upper shoulder strap wound around the adjustment buckle, as well as the adjusting portion and the connecting portion of the lower shoulder strap, the clamping sheet is used to be clamped with the upper shoulder strap wound at the adjustment buckle from a relative front face or back face of the adjustment buckle, the hanger sheet is used to be inserted into the adjustment buckle and clamped with the adjustment buckle on the relative front face of the adjustment buckle.

Preferably, an edge of a relative left end or relative right end of the protective sheet is recessed toward an opposite side to form a notch, such that the clamping sheet is formed on the protective sheet due to division of the notch.

Preferably, the notch is disposed at a relative upper end or a relative center of the relative left end or relative right end of the protective sheet, and a closed end of the notch is located at a position close to a centerline of the protective sheet.

Preferably, the positioning member further includes a closure member disposed at an open end of the notch for opening and closing the open end of the notch.

Preferably, the hanger sheet includes an assembling portion and a clamping joint, one end of the assembling portion is in sewn connection with the protective sheet, the other end of the assembling portion is in sewn connection with the clamping joint, the clamping joint is clamped on the adjustment buckle in a longitudinal direction of the adjustment buckle after passing through from a relative back face of the adjustment buckle to a relative front face of the adjustment buckle.

Preferably, the clamping joint is T-shaped or bowknot shaped.

Preferably, a support member is disposed within the clamping joint, and the support member has certain hardness and elasticity to prevent the clamping joint from separating from the adjustment buckle.

Preferably, the head protection device further comprises a limiting member, the limiting member is in sewn connection with the protective sheet below the positioning member, and has a limiting space for the shoulder strap to pass through.

Preferably, the limiting member is annular or semi-annular, and has certain elasticity.

In order to achieve the above purposes, the invention also provides an infant carrier, which comprises a seat body, a backrest connected to the seat body, and two shoulder straps connected between the seat body and the backrest, wherein the two shoulder straps are detachably connected to the seat body respectively, each of the two shoulder straps is wound with an adjustment buckle correspondingly, and the adjustment buckles are is used for adjusting lengths of the shoulder straps, characterized in that the infant carrier further comprises a head protection device sleeved outside the shoulder straps and the adjustment buckles as described above.

Preferably, the infant carrier of the invention further comprises two waist straps, a crotch strap, and a connecting buckle, the two waist straps are symmetrically arranged on left and right opposite sides of a seating area of the seat body, the crotch strap is arranged at a relative center of the seating area of the seat body, and the two shoulder straps, the two waist straps, and the crotch strap are detachably connected to the seat body by connecting with the connecting buckle respectively.

Compared with the prior art, the head protection device of the invention includes the connecting members and the positioning member disposed on the protective sheet, and the protective sheet is detachably sleeved outside the adjustment buckle and the shoulder strap wound around the adjustment buckle by the connecting members. Since the shoulder strap is connected between the backrest and the seat body of the infant carrier, in combination with the positioning members clamped with the adjustment buckle and/or the shoulder strap wound around the adjustment buckle, in actual use, no matter the infant bumps against the protective sheet during sitting or the shoulder strap slides in respect to the adjustment buckle during a length adjustment, the protective sheet is always clamped with the adjustment buckle and/or the shoulder strap wound around the adjustment buckle, so there is no relative sliding occurred between the sleeved shoulder strap and the adjustment buckle, such that the adjustment buckle and the shoulder strap wound around the adjustment buckle are always wrapped in the protective sheet, thereby effectively improving safety and comfort in use. The head protection device of the invention has a simple structure, is easy to use, and is safe and reliable, which can effectively ensure safety and comfort of the head protection device having the infant carrier.

### BRIEF DESCRIPTION OF THE DRAWINGS

FIG. 1 is a structural schematic view of an infant carrier of the invention.

FIG. 2 is a schematic view of a first structure of a shoulder strap of the invention.

FIG. 3 is a schematic view of a second structure of a shoulder strap of the invention.

FIG. 4 is a front structural schematic view of a head protection device of a first embodiment of the invention.

FIG. 5 is a back structural schematic view of the head protection device of the first embodiment of the invention.

FIG. 6 is a schematic view of the head protection device of the first embodiment in a sleeved connection mode with the shoulder straps of the first structure.

FIG. 7 is a schematic view of the head protection device of the first embodiment in another sleeved connection mode with the shoulder straps of the first structure.

FIG. 8 is a schematic view of the head protection device of the first embodiment being sleeved with the shoulder straps of the second structure.

FIG. 9 is a front structural schematic view of the head protection device of a second embodiment of the invention.

FIG. 10 is a back structural schematic view of the head protection device of the second embodiment of the invention.

FIG. 11 is a schematic view of the head protection device of the second embodiment being sleeved with the shoulder straps of the first structure.

FIG. 12 is a structural schematic view of the head protection device of a third embodiment of the invention.

FIG. 13 is a structural schematic view of a support member disposed in a clamping joint shown in FIG. 12.

FIG. 14 is a schematic view of the head protection device of the third embodiment being sleeved with the shoulder straps of the first structure.

FIG. 15 is a structural schematic view of the head protection device of a fourth embodiment of the invention.

FIG. 16 is a structural schematic view of the support member disposed in the clamping joint shown in FIG. 15.

FIG. 17 is a schematic view of the head protection device of the fourth embodiment being sleeved with the shoulder straps of the first structure.

### DETAILED DESCRIPTION

In order to describe the technical content, structural features, achieved objects and effects of the present invention in detail, the following are illustrated in detail in conjunction with the embodiments and the accompanying drawings.

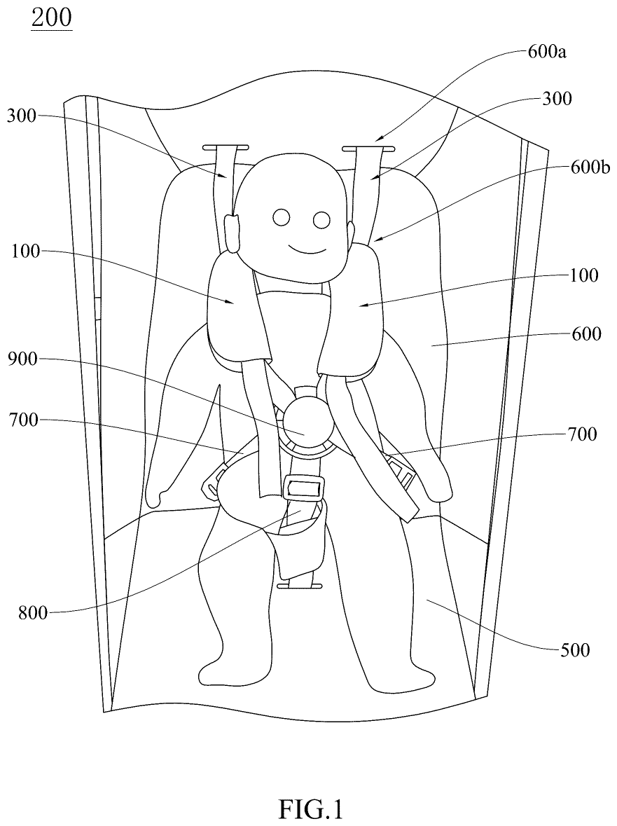

Please refer to FIGS. 1 to 3, the invention provides a head protection device 100, which is suitable for being sleeved outside a shoulder strap 300 of an infant carrier 200 and the adjustment buckle 400 wound around the shoulder strap 300, furthermore, there is no relative sliding between head protection device 100, the adjustment buckle 400 and the shoulder strap 300 wound around the adjustment buckle 400. In the application, the infant carrier 200 of the invention includes, but is not limited to, for example, a baby stroller, a baby basket, a sleeping box, a safety seat, a baby chair, and the like. Specifically, the infant carrier 200 of the invention includes a seat body 500 and a backrest 600 connected to the seat body 500. Two shoulder straps 300 are symmetrically connected between the seat body 500 and the backrest 600. In order to adapt to the use of infants of different ages and sizes, the shoulder straps 300 are arranged to be adjustable in length, and the adjustment buckles 400 are used to adjust lengths of the shoulder straps 300, so as to adaptively secure the infant sitting in the infant carrier 200 by the two shoulder straps 300 to ensure safety in use. The adjustment buckles 400 are specifically selected from a two-eye-buckle (8-shaped buckle) or a three-eye-buckle, which is convenient, economical and practical in use. According to requirements, some of the infant carriers 200 are also symmetrically arranged with two waist straps 700 on both left and right opposite sides of a seating area of the seat body 500, and a crotch strap 800 is arranged at a relative center of the seating area of the seat body 500, that is, at a position between two legs of the corresponding infant. The two shoulder straps 300, the two waist straps 700, and the crotch strap 800 are correspondingly connected to a connecting buckle 900, such that they are respectively detachably connected to the seat body 500 by a connecting buckle 900. When in use, the connecting buckle 900 is generally located at a position of the waist and abdomen of the infant. More specifically, the head protection device 100 of the invention is detachably wrapped outside the shoulder strap 300.

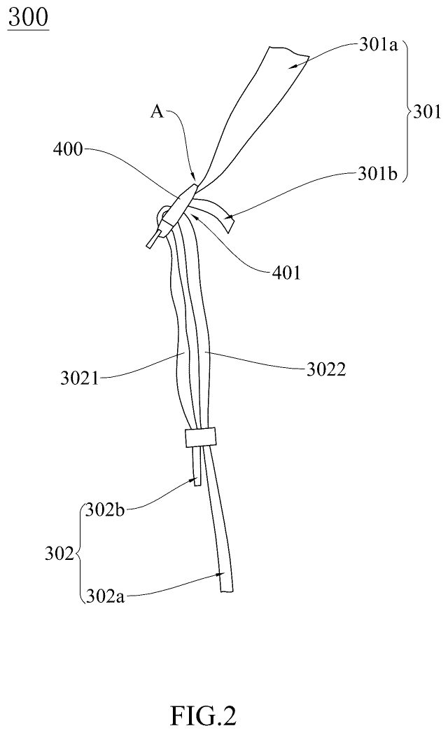

In conjunction with FIGS. 1 and 2, each the shoulder straps 300 has a following first structure: including an upper shoulder strap 301 and a lower shoulder strap 302 wound around the adjustment buckle 400, the upper shoulder strap 301 and the lower shoulder strap 302 are correspondingly wound around both upper and lower opposite sides of the adjustment buckle 400, and there is also a passing gap 401 between the upper shoulder strap 301 and the lower shoulder strap 302 wound around the adjustment buckle 400. The upper shoulder strap 301 includes an upper connecting end 301a and a lower connecting end 301b respectively located at its head and tail ends. The upper connecting end 301a is connected to a relative upper end 600a of the backrest 600, and the lower connecting end 301b is connected to a relative middle upper end 600b of the backrest 600 after being wound around the adjustment buckle 400. The lower shoulder strap 302 has a connecting end 302a and a free end 302b respectively arranged at its head and tail ends, and the connecting end 302a is connected to the seat body 500. Specifically, the lower shoulder strap 302 can be detachably connected to the connecting buckle 900 by a buckle connected at the connecting end 302a, thereby achieving connection between the lower shoulder strap 302 and the seat body 500. After the free end 302b of the lower shoulder strap 302 is wound around the adjustment buckle 400, an adjusting portion 3021 is formed between the free end 302b and the adjustment buckle 400, and a connecting portion 3022 is formed between the connecting end 302a and the adjustment buckle 400. When in use, a relative length of the connecting portion 3022 can be adjusted by pulling the adjusting portion 3021, so as to change a length of the entire shoulder strap 300 to satisfy use requirements of different infants.

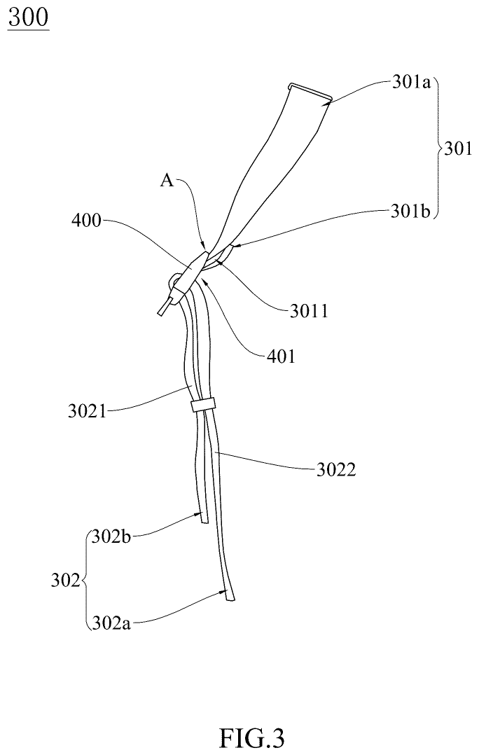

In conjunction with FIGS. 1 and 3, what differs the second structure from the first structure of the shoulder strap 300 lies in: the lower connecting end 301b of the upper shoulder strap 301 is folded upward to be connected to a strap body of the upper shoulder strap 301 after being wound around the adjustment buckle 400, such that on an opposite back of the adjustment buckle 400, a passing hole 3011 is formed between the lower connecting end 301b and the upper shoulder strap 301. All other parts of the shoulder strap 300 of this structure are basically consistent with those of the first structure, and will not be redundantly described here. Specifically, when in use, the length of the connecting portion 3022 is also adjusted by pulling the adjusting portion 3021, thereby changing the length of the entire shoulder strap 300.

It should be note, in the shoulder straps 300 of the two structures mentioned above, both connections between the lower connecting end 301b of the upper shoulder strap 301 and the corresponding relative middle upper end 600b of the backrest 600 or the strap body of the upper shoulder strap 301 are fixed connections, such as sewn connections, 8-shaped buckle or three-eye-buckle connections. The upper connecting end 301a of the upper shoulder strap 301 may be is in sewn connection with the relative upper end 600a of the backrest 600, or be detachably connected to the backrest 600 by a buckle with a relative simple structure. Of course, the upper connecting end 301a can also pass through the backrest 600 and be wound up in a webbing winder disposed on a back face of the backrest 600, thereby increasing length of the shoulder strap 300 and effectively improving adaptability of the shoulder strap 300. In addition, although the shoulder strap 300 of the invention is described including the upper shoulder strap 301 and the lower shoulder strap 302 in separated structures, but the invention is not limited thereto. Specifically, when the shoulder strap 300 is simplified to be connected to an integrated structure between the seat body 500 and the backrest 600, as long as the head protection device 100 of the invention is still wrapped outside the shoulder strap 300 and the adjustment buckle 400, and is clamped with the adjustment buckle 400 and the shoulder strap 300 at the adjustment buckle 400, there will be no relative sliding.

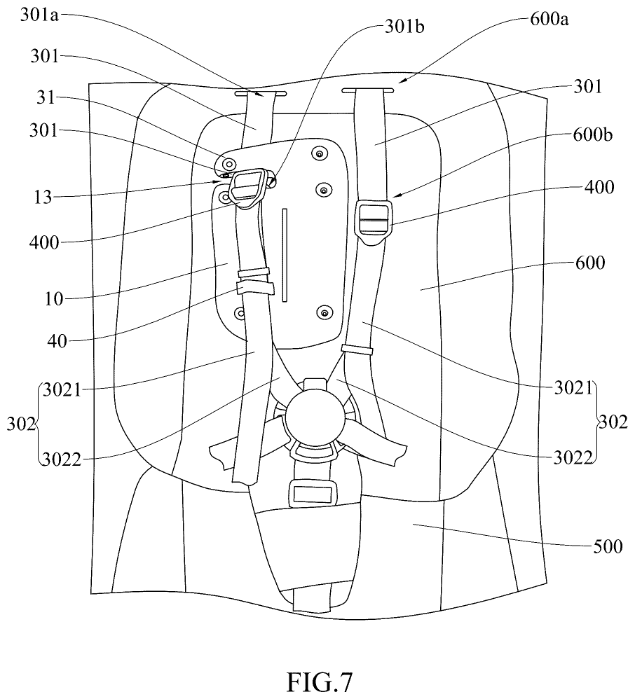

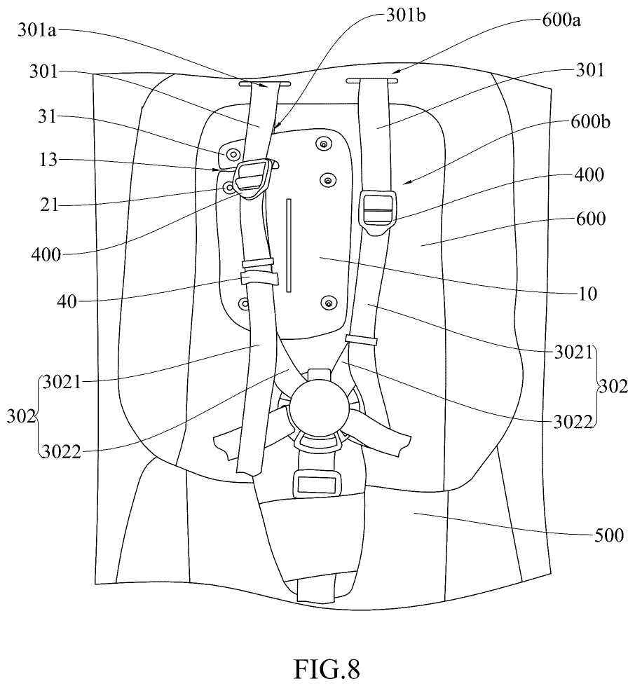

The structure of the head protection device 100 of the first embodiment of the invention will be described in conjunction with FIGS. 2 to 8 hereinbelow:

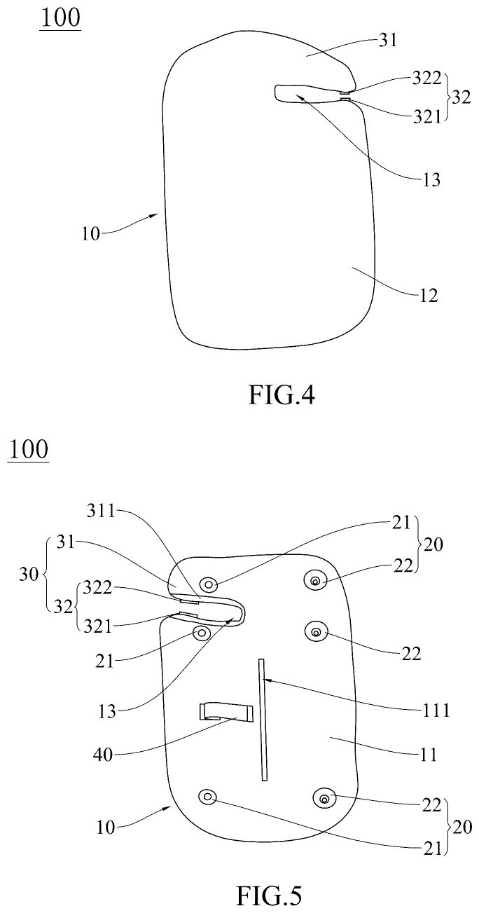

Referring to FIGS. 4 and 5, the head protection device 100 includes a protective sheet 10 and connecting members 20 and a positioning member 30 which are disposed on the protective sheet 10. Left and right ends of the protective sheet 10 are detachably connected by the connecting members 20, so the protective sheet 10 can be sleeved outside the shoulder strap 300 and the adjustment buckle 400. The positioning member 30 is used for clamping with the adjustment buckle 400 and/or the shoulder strap 300 wound at the adjustment buckle 400, such that the adjustment buckle 400 and the shoulder strap 300 wound at the adjustment buckle 400 are always wrapped in the protective sheet 10. When in use, firstly, the head protection device 100 is placed between the backrest 600 and the shoulder strap 300 and is aligned at position of the adjustment buckle 400, then, after the positioning member 30 is clamped with and the adjustment buckle 400 and/or the shoulder strap 300 wound at the adjustment buckle 400, one of a relative left end and a relative right end of the protective sheet 10 is bent or rolled in a direction toward the other, such that the left and right ends of the protective sheet 10 are abutted against or overlapped with each other, and are connected and fixed by the connecting members 20, such that the protective sheet 10 can be conveniently and quickly sleeved outside the adjustment buckle 400 and the shoulder strap 300 wound at the adjustment buckle 400. Among them, in this embodiment, the protective sheet 10 is arranged in a longitudinal direction of the shoulder strap 300, so as to be wrapped outside the adjustment buckle 400 and a wrapping place of the shoulder strap 300 which is wrapped with the adjustment buckle 400, and outside an extending place of the shoulder strap 300 which is connected to the wrapping place, and accordingly, the protective sheet 10 is relatively long, such that it can wrap outside the shoulder strap 300 in a longer range, with better safety and comfort.

Referring to FIGS. 4 and 5, the protective sheet 10 is sheet-shaped, roughly in a shape of a rectangle, relatively soft, and has certain elasticity. Specifically, the protective sheet 10 includes a wrapping layer 11 and a fitting layer 12 which are sewn connected together as a whole. The wrapping layer 11 is used to contact the shoulder strap 300 and the adjustment buckle 400, and the fitting layer 12 is used to contact the head and neck of the infant. Specifically, the protective sheet 10 also includes a buffer layer (not shown because it is hidden between the wrapping layer 11 and the fitting layer 12). The buffer layer is disposed between the wrapping layer 11 and the fitting layer 12, and the wrapping layer 11, the buffer layer and the fitting layer 12 are sewn connected together as a whole. Among them, a buffer layer may be arranged a side of at least one of the wrapping layer 11 and the fitting layer 12 opposite to the other of the wrapping layer 11 and the fitting layer 12, that is, the wrapping layer 11 and/or the fitting layer 12 themselves have buffer layers. Of course, it is also possible to add a buffer layer and the buffer layer is sewn connected together with the wrapping layer 11 and the fitting layer 12 as a whole. In order to facilitate processing and use, edges of both the wrapping layer 11 and the fitting layer 12 may also be sewn connected together as a whole. The wrapping layer 11 is provided with a filling port 111, and the buffer layer is detachably filled between the wrapping layer 11 and the fitting layer 12 by the filling port 111, so as to facilitate removing and washing, and it is more healthy and hygienic to use. It should be note, when the wrapping layer 11 and/or the fitting layer 12 itself has a buffer layer, or, when the buffer layer is sewn connected together with the wrapping layer 11 and the fitting layer 12 as a whole, the filling port 111 may be an indentation line sewn on a central axis of the protective sheet 10, so as to facilitate bending of the protective sheet 10. Among them, the wrapping layer 11 and the fitting layer 12 may be made of at least one of a fiber fabric, a cotton material, or a leather material, and the buffer layer may be made of at least one of a latex, a memory foam, or a silicone material.

Referring to FIG. 5, the connecting members 20 are specifically disposed on edges of the relative left end and the relative right end of the protective sheet 10. The number of the connecting members 20 may be multiple, and the multiple connecting members 20 may be arranged separately along the longitudinal direction of the protective sheet 10, such that the protective sheet 10 can be more securely sleeved on the shoulder strap 300 by arrangement of a plurality of connecting points. Specifically, the connecting members 20 may be any one of a fixed buckle and a fixed hole being detachable and cooperative to each other, a buckle, a string and a Velcro. In this embodiment, the connecting members 20 is a snap button, which includes a male button 21 and a female button 22 arranged to be spaced apart along a width direction of the protective sheet 10. Through buckled connection or separation of the male button 21 and the female button 22, attachment and detachment of the protective sheet 10 on the shoulder strap 300 can be simply and conveniently realized, which is convenient to use and effectively reduces the manufacturing cost.

Referring to FIGS. 4 and 5, the positioning member 30 may be clamped with the shoulder strap 300 along the width direction of the shoulder strap 300. Specifically, in this embodiment, the positioning member 30 includes a clamping sheet 31 disposed on the protective sheet 10, and the clamping sheet 31 is used to be clamped with the shoulder strap 300 wound at the adjustment buckle 400 from a relative front face or a relative back face of the adjustment buckle 400, specifically, to be clamped with the upper shoulder strap 301 of the shoulder strap 300. Specifically, the edge of the relative left end or the relative right end of the protective sheet 10 is recessed toward an opposite side to form a notch 13, such that a clamping sheet 31 is formed on the protective sheet 10 due to division of the notch 13. The notch 13 is specifically disposed at a relative upper end of the relative left end or the relative right end of the protective sheet 10, and a closed end of the notch 13 is located at a position close to a centerline of the protective sheet 10. A width of the notch 13 is corresponding to a thickness of the shoulder strap 300, so as to facilitate clamping between the clamping sheet 31 and the shoulder strap 300.

Referring to FIGS. 4 and 5, preferably, the positioning member 30 also includes a closure member 32 disposed at an open end of the notch 13. The closure member 32 is used for opening and closing of the open end of the notch 13, thereby strengthening clamping between the clamping sheet 31 and the shoulder strap 300. Specifically, the closure member 32 is any one of a fixed buckle and a fixed hole being detachable and cooperative to each other, a buckle, a string and a Velcro. In this embodiment, the closure member 32 is chosen to be a Velcro, including a mother sticker 321 and a sub-sticker 322 disposed on opposite side walls of the notch 13. By attaching or separating of the mother sticker and the sub-sticker, opening and closing of the notch 13 can be simply and conveniently realized, which is easy to use, and effectively reduce manufacturing costs.

Referring to FIGS. 4 and 5, the head protection device 100 of the invention also includes a limiting member 40. The limiting member 40 is in sewn connection with the protective sheet 10 below the positioning member 30, and has a limiting space for the shoulder strap 300 to pass through, thereby constraining the shoulder strap 300 wrapped in the protective sheet 10, which can not only further strengthen connection between the protective sheet 10 and the shoulder strap 300, but also limit a sliding direction of the shoulder strap 300, such that the overall shoulder strap 300 is more tidy. Specifically, the limiting member 40 is annular or semi-annular, and has certain elasticity. In this embodiment, both ends of the semi-annular limiting member 40 are in sewn connection with the protective sheet 10, such that the limiting space for the shoulder strap 300 to pass through is formed between the limiting member 40 and the protective sheet 10, which reduces manufacturing cost accordingly.

In conjunction with FIGS. 2, 5 and 6, when the head protection device 100 of this embodiment is used on the infant carrier 200 having the shoulder strap 300 of the first structure, the protective sheet 10 as a whole is detachably wrapped outside the adjustment buckle 400 and the upper shoulder strap 301 wound around the adjustment buckle 400, as well as the adjusting portion 3021 and the connecting portion 3022 of the lower shoulder strap 302. The upper shoulder strap 301 located between the relative middle upper end 600b of the backrest 600 and the adjustment buckle 400 is inserted into the notch 13, such that the clamping sheet 31 is clamped on a back face of the adjustment buckle 400 with the upper shoulder strap 301 wound at the adjustment buckle 400, and a clamping surface 311 of the clamping sheet 31 clamped with the upper shoulder strap 301 is a plane. Then, when the adjusting portion 3021 is pulled to adjust the length of the shoulder strap 300, the clamping sheet 31 is always clamped with the upper shoulder strap 301, such that the adjustment buckle 400 and the upper shoulder strap 301 wound around the adjustment buckle 400, as well as the adjusting portion 3021 and the connecting portion 3022 of the lower shoulder strap 302 are always wrapped in the protective sheet 10, which is safe and comfortable to use. When closure member 32 is cooperatively used, the clamping effect will be better, and when the adjusting portion 3021 and the connecting portion 3022 of the lower shoulder strap 302 on the adjustment buckle 400 are placed to pass through the limiting member 40, the use effect will be better.

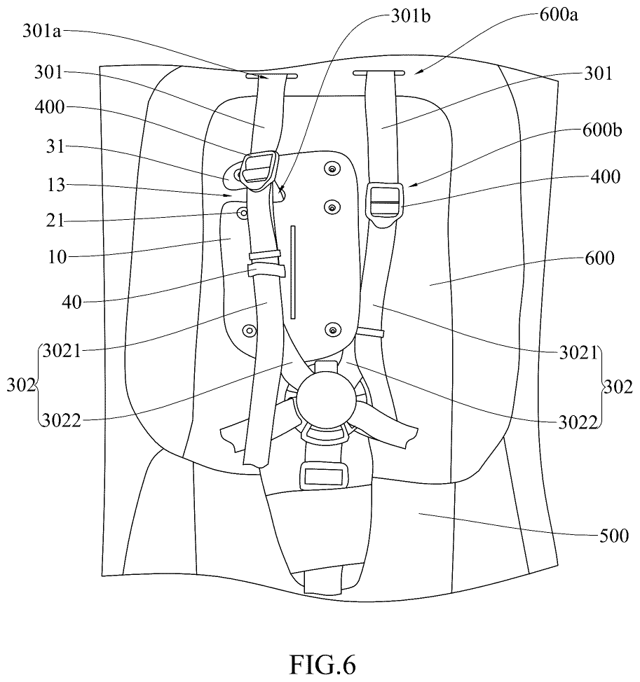

In conjunction with FIGS. 2, 5, and 7, when the head protection device 100 of this embodiment is used on the infant carrier 200 having the shoulder strap 300 of the first structure, another clamping method may also be used, which is different from the clamping method shown in FIG. 6 in that the clamping position of the clamping sheet 31 and the upper shoulder strap 301 is different. At this time, the upper shoulder strap 301 located between the lower connecting end 301b and the adjustment buckle 400 is inserted into the notch 13, and the clamping sheet 31 is clamped with the upper shoulder strap 301 wound at a winding in end A of the adjustment buckle 400 on the relative front face of the adjustment buckle 400, that is, the clamping sheet 31 is clamped at a position between the upper shoulder strap 301 and the winding in end A of the adjustment buckle 400, such that the clamping sheet 31 is always clamped with the upper shoulder strap 301 at the adjustment buckle 400, such that the adjustment buckle 400 and the upper shoulder strap 301 wound around the adjustment buckle 400, as well as the adjusting portion 3021 and the connecting portion 3022 of the lower shoulder strap 302 are always wrapped in the protective sheet 10, which is safe and comfortable to use. Among them, in this specific embodiment, the clamping surface 311 of the clamping sheet 31 is preferably a slope, which can effectively improve firmness of the clamping. In such case, if the closure member 32 and/or the limiting member 40 are cooperatively used, the clamping will have a better effect.

In conjunction with FIGS. 3, 5, and 8, when the head protection device 100 of this embodiment is used on the infant carrier 200 having the shoulder strap 300 of the second structure, what differs from the clamping method shown in FIG. 6 lies in: although the clamping sheet 31 is clamped on the relative back face of the adjustment buckle 400 with the upper shoulder strap 301 wound between the adjustment buckle 400 and the lower connecting end 301b, the clamping sheet 31 is specifically passing through the passing hole 3011, and the notch 13 is clamped with the upper shoulder strap 301 wound between the adjustment buckle 400 and the lower connecting end 301b, firmness of the clamped connection can be more effectively improved through double clamping. At this time, if the closure member 32 and/or the limiting member 40 are cooperatively used, the clamping effect will be better. It should be note, in the shoulder strap 300 of this structure, the clamping method between the clamping sheet 31 and the upper shoulder strap 301 may also be as follows: on a relative front face of the adjustment buckle 400, the clamping sheet 31 is clamped with the upper shoulder strap 301 wound at the winding in end A of the adjustment buckle 400, that is, the clamping sheet 31 is clamped at a position between the upper shoulder strap 301 and the winding in end A of the adjustment buckle 400, and the upper shoulder strap 301 located at the winding in end A on the relative front face of the adjustment buckle 400 and at a winding out end on the relative back face of the adjustment buckle 400 is correspondingly inserted into the notch 13, such that the clamping sheet 31 is always clamped with the upper shoulder strap 301 at the adjustment buckle 400, thereby making the adjustment buckle 400 and the upper shoulder strap 301 wound around the adjustment buckle 400, as well as the adjusting portion 3021 and the connecting portion 3022 of the lower shoulder strap 302 are always wrapped in the protective sheet 10, which is safe and comfortable to use.

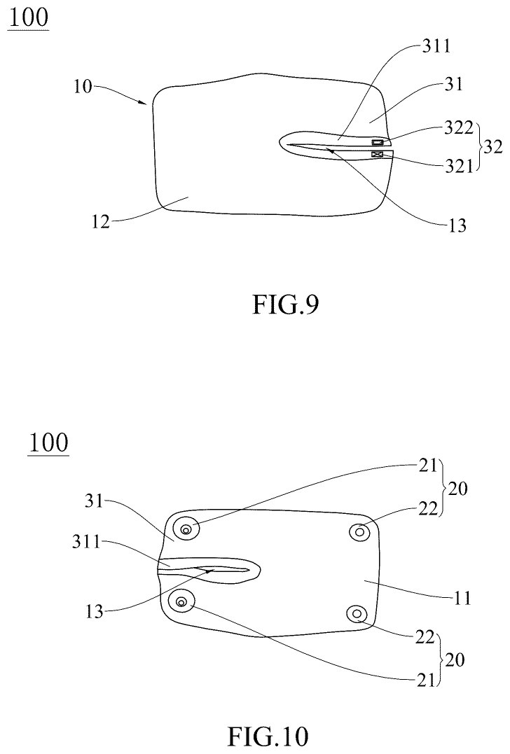

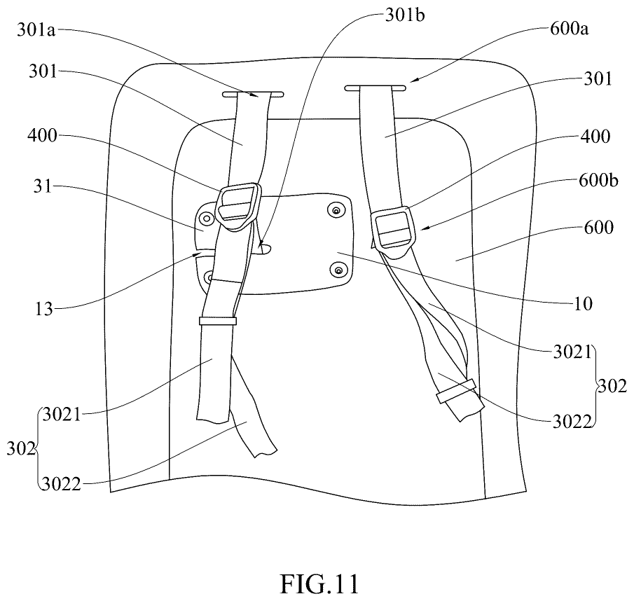

The structure of the head protection device 100 of the second embodiment of the invention will be described in conjunction with FIGS. 9 to 11 hereinbelow:

What differs this embodiment from the first embodiment mainly lies in: the protective sheet 10 is arranged in a transverse width direction of the shoulder strap 300, thereby being only wrapped outside the adjustment buckle 400 and the shoulder strap 300 wound around the adjustment buckle 400. In this embodiment, the protective sheet 10 is relatively short, and mainly wrapped outside the adjustment buckle 400, so it is wrapped outside the shoulder strap 300 only in a shorter length, thus saving costs. Correspondingly, the notch 13 is arranged at a relative center of the relative left end or the relative right end of the protective sheet 10. Other structures of the head protection device 100 of this embodiment are basically the same as those of the head protection device 100 of the first embodiment, and will not be redundantly repeated here.

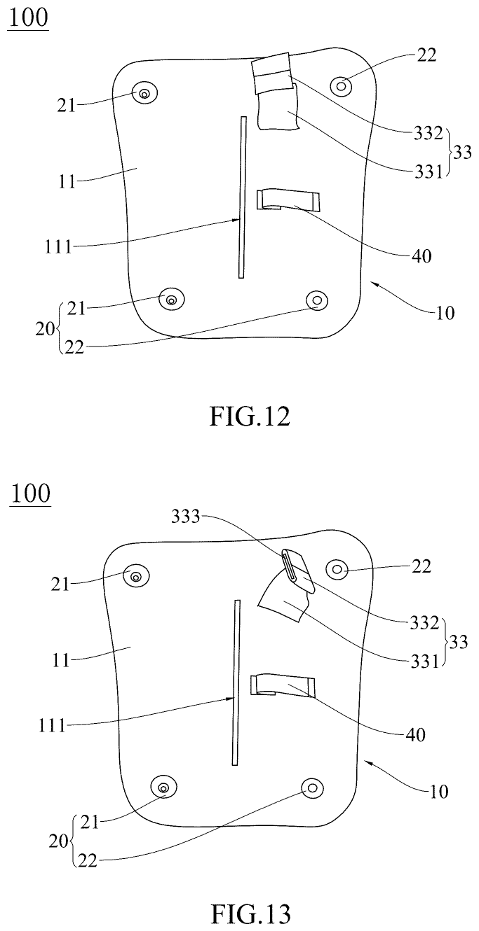

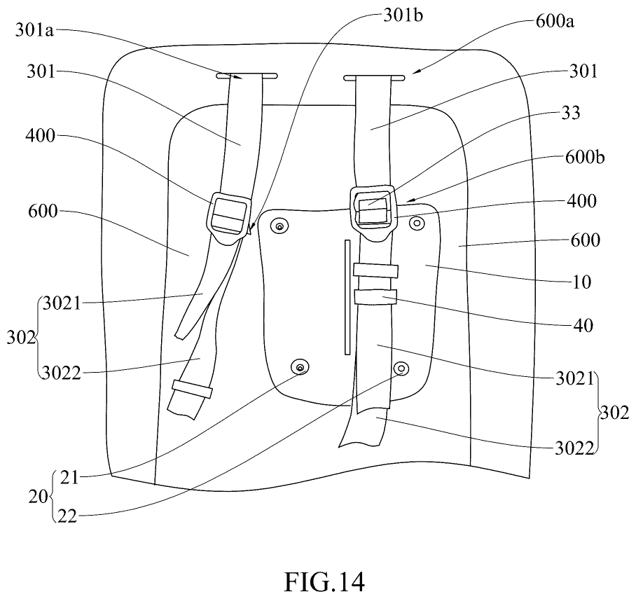

The structure of the head protection device 100 of the third embodiment of the invention will be described in conjunction with FIGS. 12 to 14 hereinbelow:

What differs this embodiment from the first embodiment mainly lies in: the structure of the positioning member 30 is different, it is unnecessary to arrange a notch 13 on the protective sheet 10, and it is unnecessary to arrange a closure member 32. In this embodiment, the positioning member 30 can be clamped with the adjustment buckle 400 in a thickness direction of the shoulder strap 300. The positioning member 20 includes a hanger sheet 33 disposed on the protective sheet 10. The hanger sheet 33 is used to be inserted into the adjustment buckle 400, and be clamped with the adjustment buckle 400. Specifically, the hanger sheet 33 includes an assembling portion 331 and a clamping joint 332. One end of the assembling portion 331 is in sewn connection with the protective sheet 10, and the other end of the assembling portion 331 is in sewn connection with the clamping joint 332. The clamping joint 332 can be clamped on the adjustment buckle 400 in the longitudinal direction of the adjustment buckle 400 after passing through (specifically, passing through the passing gap 401 between the upper shoulder strap 301 and the lower shoulder strap 302 wound around the adjustment buckle 400) from the relative back face of the adjustment buckle 400 to the relative front face of the adjustment buckle 400, so as to be clamped with the adjustment buckle 400. If the adjusting portion 3021 and the connecting portion 3022 of the lower shoulder strap 302 on the adjustment buckle 400 is placed to pass through the limiting member 40, the use effect is better. Specifically, the clamping joint 332 is T-shaped or bowknot shaped. Preferably, a support member 333 is disposed within the clamping joint 332. The support member 333 has certain hardness and elasticity to prevent the clamping joint 332 from separating from the adjustment buckle 400. Specifically, the support member 333 is chosen to be a plastic sheet.

It should be note, in conjunction with FIGS. 2 and 3, in this embodiment, either being sleeved on the shoulder strap 300 of the first structure or on the shoulder strap 300 of the second structure, and no matter how the shoulder strap 300 slides in respect with the adjustment buckle 400, the hanger sheet 33 is always clamped on the adjustment buckle 400, such that there is no relative sliding between the protective sheet 10 and the adjustment buckle 400, thereby making the adjustment buckle 400 and the upper shoulder strap 301 wound around the adjustment buckle 400, as well as the adjusting portion 3021 and the connecting portion 3022 of the lower shoulder strap 302 be always wrapped in the protective sheet 10, which is safer and more comfortable to use.

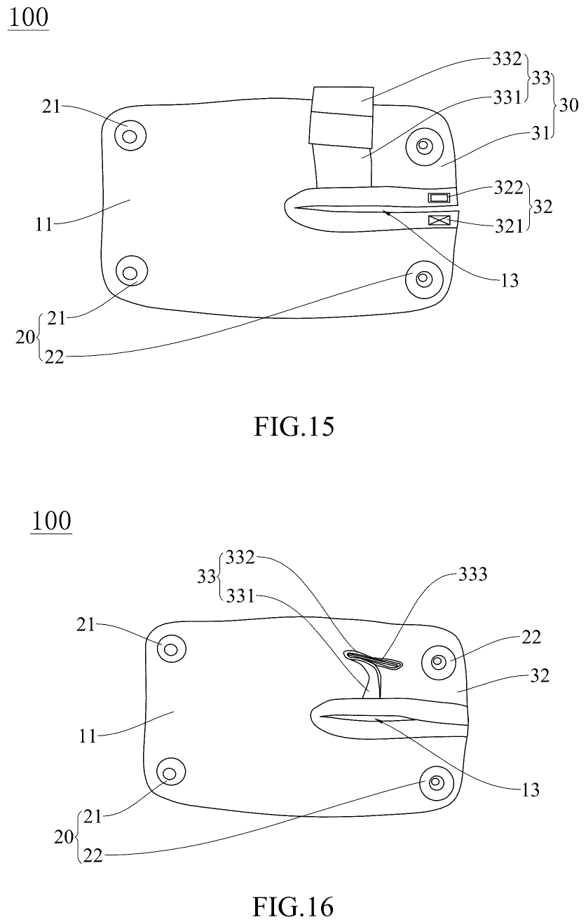

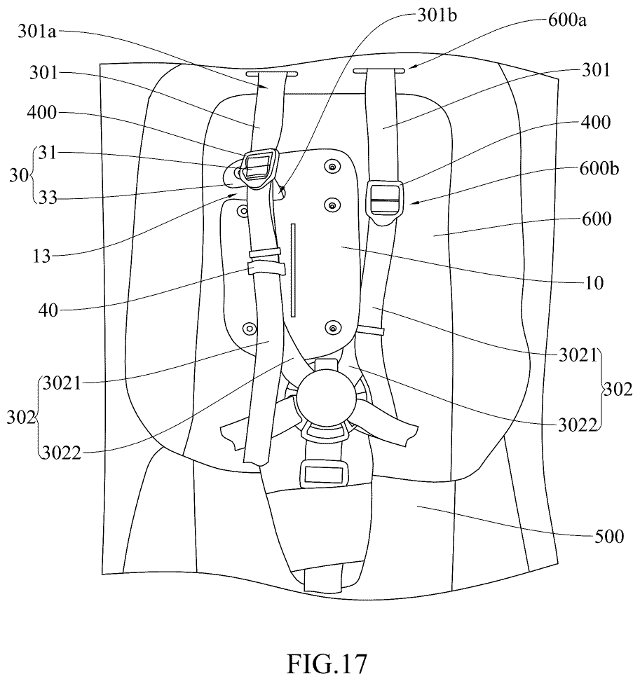

The structure of the head protection device 100 of the fourth embodiment of the invention will be described in conjunction with FIGS. 15 to 17 hereinbelow:

What differs this embodiment from the first embodiment mainly lies in that the structure of the positioning member 30 is different. In this embodiment, the positioning member 30 can be clamped with the adjustment buckle 400 in the thickness direction of the shoulder strap 300, can also be clamped with the shoulder strap 300 wound around the adjustment buckle 400 in the transverse width direction of the shoulder strap 300, specifically be clamped with the upper shoulder strap 301. Then the positioning member 30 includes not only the clamping sheet 31, but also the hanger sheet 33 in third embodiment. At this time, the hanger sheet 33 is disposed at an edge of the notch 13, which can further strengthen firmness of clamping between the protective sheet 10 and the shoulder strap 300 and the adjustment buckle 400 by double clamping, thereby further improving safety and comfort in use. The specific clamping structures between the clamping sheet 31 and the upper shoulder strap 301 and between the hanger sheet 33 and the adjustment buckle 400 are consistent with those in the first and third embodiments accordingly, and will not be redundantly repeated here.

Compared with the prior art, the head protection device 100 of the invention includes the connecting members 20 and the positioning member 30 disposed on the protective sheet 10, and the protective sheet 10 is detachably sleeved outside the adjustment buckle 400 and the shoulder strap 300 wound around the adjustment buckle 400 by the connecting members 20. Since the shoulder strap 300 is connected with adjustable lengths between the backrest 600 and the seat body 500 of the infant carrier 200, in combination with the positioning members 30 clamped with the adjustment buckle 400 and/or the shoulder strap 300 wound around the adjustment buckle 400, in actual use, no matter the infant bumps against the protective sheet 10 during sitting or the shoulder strap 300 slides in respect to the adjustment buckle 400 during a length adjustment, the protective sheet 10 is always clamped with the adjustment buckle 400 and/or the shoulder strap 300 wound around the adjustment buckle 400 by the positioning member 30, so there is no relative sliding occurred between the sleeved shoulder strap 300 and the adjustment buckle 400, such that the adjustment buckle 400 and the shoulder strap 300 wound around the adjustment buckle 400 are always wrapped in the protective sheet 10, thereby effectively improving safety and comfort in use. The head protection device 100 of the invention has a simple structure, is easy to use, and is safe and reliable, which can effectively ensure safety and comfort of the head protection device 100 having the infant carrier 200.

What disclosed above is only preferred embodiments of the invention, which of course cannot be used to limit the scope of the present invention. Therefore, equivalent changes made according to the scope of the patent application of the invention are still covered by the invention.

1. A head protection device, comprising
a protective sheet,
a connecting member and a positioning member both disposed on the protective sheet,
wherein left and right ends of the protective sheet are detachably connected by the connecting member, so as to be capable of being sleeved outside a shoulder strap of an infant carrier and an adjustment buckle wound around the shoulder strap, wherein the shoulder strap is connected between a backrest and a seat body of the infant carrier,
wherein the positioning member is used to be clamped with the adjustment buckle and/or the shoulder strap wound around the adjustment buckle, such that the adjustment buckle and the shoulder strap wound around the adjustment buckle are always wrapped in the head protection device.

2. The head protection device according to claim 1, wherein the protective sheet is arranged in a transverse width direction of the shoulder strap, so as to be wrapped only outside the adjustment buckle and the shoulder strap wound at the adjustment buckle.

3. The head protection device according to claim 1, wherein the protective sheet is arranged in a longitudinal direction of the shoulder strap, so as to be wrapped outside the adjustment buckle and a wrapping place of the shoulder strap which is wrapped with the adjustment buckle, and outside an extending place of the shoulder strap which is connected to the wrapping place.

4. (canceled)

5. The head protection device according to claim 4, wherein the protective sheet includes a wrapping layer and a fitting layer sewn connected together as a whole, the wrapping layer is used to contact the shoulder strap and the adjustment buckle, and the fitting layer is used to contact the infant.

6. The head protection device according to claim 5, wherein the protective sheet further includes a buffer layer, the buffer layer is disposed between the wrapping layer and the fitting layer, and the wrapping layer, the buffer layer and the fitting layer are sewn connected together as a whole.

7. The head protection device according to claim 5, wherein the protective sheet further includes a buffer layer, edges of both the wrapping layer and the fitting layer are sewn connected together as a whole, the wrapping layer is provided with a filling port, and the buffer layer is detachably filled between the wrapping layer and the fitting layer by the filling port.

8. The head protection device according to claim 1, wherein the connecting member is provided in a plurality, the plurality of connecting members are disposed on edges of a relative left end and a relative right end of the protective sheet, and the plurality of connecting members are arranged separately along a longitudinal direction of the head protection device.

9. (canceled)

10. The head protection device according to claim 1, wherein the positioning member is clamped with the shoulder strap in the transverse width direction of the shoulder strap and/or clamped with the adjustment buckle in a thickness direction of the shoulder strap.

11. (canceled)

12. The head protection device according to claim 1, wherein the positioning member includes a clamping sheet and/or a hanger sheet disposed on the protective sheet, the clamping sheet is used to be clamped with the shoulder strap wound at the adjustment buckle, and the hanger sheet is used to be inserted into the adjustment buckle and clamped with the adjustment buckle.

13. The head protection device according to claim 12, wherein the shoulder strap includes an upper shoulder strap and a lower shoulder strap both wound around the adjustment buckle, an upper connecting end of the upper shoulder strap is connected to a relative upper end of the backrest, a lower connecting end of the upper shoulder strap is connected to a relative middle upper end of the backrest after being wound around the adjustment buckle, a connecting end of the lower shoulder strap is connected to the seat body, after a free end of the lower shoulder strap is wound around the adjustment buckle, a adjusting portion is formed between the free end and the adjustment buckle, and a connecting portion is formed between the connecting end and the adjustment buckle, the protective sheet is wrapped outside the adjustment buckle and the upper shoulder strap wound around the adjustment buckle as well as the adjusting portion and the connecting portion of the lower shoulder strap, the clamping sheet is used to be clamped with the upper shoulder strap wound at the adjustment buckle from a relative front face or back face of the adjustment buckle, the hanger sheet is used to be inserted into the adjustment buckle from the relative back face of the adjustment buckle and clamped with the adjustment buckle on the relative front face of the adjustment buckle.

14. The head protection device according to claim 12, wherein the shoulder strap includes an upper shoulder strap and a lower shoulder strap both wound around the adjustment buckle, an upper connecting end of the upper shoulder strap is connected to a relative upper end of the backrest, a lower connecting end of the upper shoulder strap is folded upward to be connected to the upper shoulder strap after being wound around the adjustment buckle, a connecting end of the lower shoulder strap is connected to the seat body, after a free end of the lower shoulder strap is wound around the adjustment buckle, an adjusting portion is formed between the free end and the adjustment buckle, and a connecting portion is formed between the connecting end and the adjustment buckle, the protective sheet is wrapped outside the adjustment buckle and the upper shoulder strap wound around the adjustment buckle as well as the adjusting portion and the connecting portion of the lower shoulder strap, the clamping sheet is used to be clamped with the upper shoulder strap wound at the adjustment buckle from a relative front face or back face of the adjustment buckle, the hanger sheet is used to be inserted into the adjustment buckle and clamped with the adjustment buckle on the relative front face of the adjustment buckle.

15. The head protection device according to claim 12, wherein an edge of a relative left end or relative right end of the protective sheet is recessed toward an opposite side to form a notch, such that the clamping sheet is formed on the protective sheet due to division of the notch.

16. The head protection device according to claim 15, wherein the notch is disposed at a relative upper end or a relative center of the relative left end or relative right end of the protective sheet, and a closed end of the notch is located at a position close to a centerline of the protective sheet.

17. The head protection device according to claim 15, wherein the positioning member further includes a closure member disposed at an open end of the notch for opening and closing the open end of the notch.

18. The head protection device according to claim 12, wherein the hanger sheet includes an assembling portion and a clamping joint, one end of the assembling portion is in sewn connection with the protective sheet, the other end of the assembling portion is in sewn connection with the clamping joint, the clamping joint is clamped on the adjustment buckle in a longitudinal direction of the adjustment buckle after passing through from a relative back face of the adjustment buckle to a relative front face of the adjustment buckle.

19. The head protection device according to claim 18, wherein the clamping joint is T-shaped or bowknot shaped.

20. The head protection device according to claim 18, wherein a support member is disposed within the clamping joint, and the support member has certain hardness and elasticity to prevent the clamping joint from separating from the adjustment buckle.

21. The head protection device according to claim 1, wherein the head protection device further comprises a limiting member, the limiting member is in sewn connection with the protective sheet below the positioning member, and has a limiting space for the shoulder strap to pass through.

22. The head protection device according to claim 21, wherein the limiting member is annular or semi-annular, and has certain elasticity.

23. An infant carrier comprising a seat body, a backrest connected to the seat body, and two shoulder straps connected between the seat body and the backrest, wherein the two shoulder straps are detachably connected to the seat body respectively, each of the two shoulder straps is wound with an adjustment buckle being used for adjusting length of the shoulder strap, wherein the infant carrier further comprises a head protection device sleeved outside the shoulder straps and the adjustment buckles according to claim 1.

24. (canceled)
